(19) United States
(12) Patent Application Publication
(10) Pub. No.: US 2006/0271733 A1
(43) Pub. Date: Nov. 30, 2006

(54) Stacked drives and analyzer

(75) Inventor: Gayle Noble, Boulder Creek, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: Finisar Corporation

(21) Appl. No.: 11/138,924

(22) Filed: May 26, 2005

(51) Int. Cl. G06F 12/00

(52) U.S. Cl. 711/114

(57) ABSTRACT

Stacked data storage devices and analyzer for stacked data storage devices. A stackable data storage device can include a storage medium, a controller, a housing enclosing the storage medium and the controller. A receptacle is coupled to the controller and is configured to couple to an interface of another similarly configured stackable data storage device. An interface is also coupled to the controller and is configured to couple to a receptacle of another similarly configured stackable data storage device. The controller can also include logic that controls storage of the data according to a RAID standard. An analyzer is also described that monitors and analyzes data storage between several stacked data storage devices or a stacked data storage device and a CPU.

### CROSS-REFERENCE TO RELATED APPLICATIONS

Not applicable.

### BACKGROUND OF THE INVENTION

1. The Field of the Invention

The present invention relates generally to data storage device storage. More specifically, the present invention relates to simplified addition of disk drive storage units to a data processing system.

2. The Relevant Technology

With the low price of data storage devices today, many people can afford to install more than one in their PC. Advantageously, a second hard disk drive is an easy way to increase the total storage capacity of a data processing system, such as a PC. Unfortunately, in some instances people may be intimidated by the thought of adding a second hard disk drive to their computer themselves, and setting up the hardware and software associations between the old hard disk drive and the newly added hard disk drive unit. In addition, hardware within a computer system may limit the number and types of hard disk drives that can be added to a computer system.

Referring to FIG. 1, an illustration of a conventional hard disk drive 100 data storage device with a top portion of its housing removed is shown illustrating typical components found therein. Hard disk drives are well known in the art and can typically include a motor (not visible), spindle 110, platters 115, read/write heads 120, actuator and electronics.

The hard disk drive 100 can have one or more platters 115 in a vertically stacked orientation, and each platter 115 usually has a head 120 on each of its sides. Some smaller drives, such as 2.5 inch drives, can have six relatively small platters that are not stacked, but are in a side-by-side arrangement such that the head stack on each platter is independent and can move across its media without effecting where the other heads are on their media. The platters 115 in modem drives are often made from glass or ceramic to avoid the unfavorable thermal characteristics of the aluminum platters found in older drives. A layer of magnetic material is typically deposited/sputtered on the surface of the platters 115. The magnetic material is used to store data and the data structure of a hard disk 100 is typically arranged into concentric circles called sectors.

The platters 115 are typically mounted on the spindle 110, which is turned by the drive motor at various speeds depending on the type of hard disk drive 100. The heads 120 are used to read and write from the platters 115 and can be spring-loaded airfoils. These heads hover above the surface of the platters 115 at a distance typically measured in micro-inches. A disk drive 100 stores information by applying a magnetic field to the moving surface of a disk coated with a magnetic material. Hard disk drives 100 provide the data storage on which essentially all modem computers depend.

A hard disk drive interface 135 is the hardware that manages the exchange of data between a computer and the hard disk drive 100. Most often with computers, the Advanced Technology Attachment interface 135, also known as the ATA (or IDE) interface is used. Hard disk drives 100 that use this interface come in a variety of types, such as Ultra ATA, Ultra DMA, or EIDE, depending on the vendor. Other interfaces may also be used such as serial attached SCSI (SAS) and Serial ATA (SATA).

The development and implementation of the IDE interface 135 moved most of the electronics and firmware (low-level software on a chip) from a controller in the computer to a printed circuit board controller on the drive 100 itself. In this process, a buffer/cache memory was added to the electronics to speed-up the process of reading and writing hard disk drive data.

A hard disk drive is, as described above, a complex device and it can be appreciated that adding and configuring a hard disk drive can be a daunting experience to a person with little or no experience in upgrading computer components. Typically, disk drives in desktops today implementing the ATA interface standard are arranged in the conventional “master” and “slave orientation. An example of a typical process for adding a new master hard disk drive can include locating the original master drive (e.g. the drive attached to the end of an IDE cable) connected to a secondary IDE port, changing the jumper on the back of the original drive from master to slave and connecting this slave drive to the middle connector on the IDE ribbon cable attached to the primary IDE port. Next, the new hard disk drive can be attached to the last connector on the ribbon cable connected to the secondary IDE port, which sets it up as the master device on that port. A power cable is attached to the new hard disk drive from the power supply. The PC is turned on and Windows is booted up. If “My Computer” shows the drive then it was successful. If not, then a partition may need to be created and/or other connection and compatibility complications may be encountered.

For ATA drives, the additional drive can also be connected on the end of the cable. However, an ATA cable typically only supports two drives, one master and one slave, and an ATA port typically only supports one cable. This limits the number of ATA units to four on a standard computer mother board. SATA drives usually include only one connector per cable, and with two connectors available on motherboards that support SATA cables, the number of SATA units that can be connected to the motherboard is limited as well.

In some instances, there may be a more compelling reason to install two hard disk drives to a computer than to simply add more storage capacity. Data accessibility and data protection are other reasons. A redundant array of independent disks, or RAID, is one example of a system that can be used to improve data access as well as provide data protection. RAID arrays can be set up in several known ways, and typically require at least two identical drives.

In RAID, the hard disk drives are not run independently, but are managed by an external RAID controller and defined according to a predefined RAID scheme. Secondary hard disk drive storage can be added, such as striped RAID 0 hard disk drive units to increase data access speed. RAID 1 mirrored hard disk drive storage units can also be added to protect data stored by supplying redundant storage units in the case of failure of one of the primary hard disk drive storage units.

However, people may be deterred from understanding and setting up or expanding such a distributed hard disk drive storage system in many instances because of the current complexities of such systems. They may also be deterred from purchasing required racks, cables, controllers, and other components that may be limited in the number of hard disk drive units that can be later added because of this reduced flexibility of such systems and components. In addition, adding additional hard disk drive storage can often result in undesirable risks of data loss and downtime for a particular computer system.

A mirroring RAID 1 array instantly and automatically copies all the data stored on one drive onto a second drive. Typically, to avoid potential complications, both drives should be the same size. Mirroring can be an expensive type of fault tolerance since it requires twice as much storage space as data stored. With a RAID 1 configuration, data is protected in the event that the primary hard disk drive fails. In the instance of failure of the primary drive, a PC can instantly switch to the secondary drive. Not only will the stored data be saved, but there will typically not be any unacceptable downtime in use of the computer and access to the data in memory.

Another method of fault tolerance is parity. Parity usually requires a minimum of three hard disk drives, but will work with several more. Data is written sequentially to each drive in the series, except the last one. The last drive stores a number that represents the sum of the data on the other drives.

Performance is enhanced by use of RAID 0, often called striping, which means that more than one hard disk drive can be writing or reading information at the same time. A RAID controller determines which drive gets which portion of data and sends the appropriate data to the appropriate drive. While that drive is writing the data, the controller sends another portion of data to the next drive or reads a portion of data from another drive. Thus, simultaneous data transfers allow for faster performance. RAID 0 may be able to double the maximum data transfer rate that each drive can provide individually. RAID 0 allows the first drive to access a packet of data while the second is transmitting one. When the second drive has finished transferring its data packet, it can access the next one while the first drive is transferring its data packet. The drawback to RAID 0 is that if either drive fails, the entire system experiences failure.

RAID 0+1 uses four identical hard disk drives, two to stripe data between one another to double their data capacity and maximum transfer rates, and two to serve as an automatic backup to the first two drives. Several other RAID configurations of hard disk drives are known to one of ordinary skill in the art.

For a functioning array, a RAID controller is typically required that will support the selected mode, in addition to the hard disk drives. These can be housed in nearly any PC, in a free PCI slot, or they may come integrated on the motherboard. The array itself is typically set up in BIOS of the RAID controller by adding all of the installed hard disk drives to be part of the array. Depending on the controller, the block size and the total capacity, initialization may take up to several hours. The selection of the block size may deserve special attention, which may further complicate setup of a RAID system.

After the operating system has booted, the new array must be formatted. Performing a Quick Format under Windows may not take much time, while a full format checks every single sector and in turn may take quite some time. After the system has rebooted, the RAID array is available under Windows as a new drive. Its use is typically no different from that of a single hard disk drive. Other questions arise, however, such as which drives should be hooked up to which IDE channel. Thus, configuring and setting up a RAID distributed hard disk drive storage system can often present difficulties for even those with experience in adding secondary hard disk drive storage to a computer system.

Other types of data storage media are known to one of ordinary skill in the art and similar problems can be experienced with these data storage devices. For example, there are magnetic, optical data storage media, as well as other types of data storage media. For example, a “Millipede” project by IBM uses thousands of nano-sharp tips to punch indentations representing individual bits into a thin plastic film rather than using traditional magnetic or electronic means to store data. Millipede technology is re-writeable (meaning it can be used over and over again), and may be able to store more than 3 billion bits of data in the space occupied by just one hole in a standard punch card. For the operation of the device the tips are brought into contact with a thin polymer film coating a silicon substrate only a few nanometers thick. Bits are written by heating a resistor built into the cantilever to a temperature of typically 400 degrees Celsius. The hot tip softens the polymer and briefly sinks into it, generating an indentation. For reading, the resistor is operated at lower temperature, typically 300 degrees Celsius, which does not soften the polymer. When the tip drops into an indentation, the resistor is cooled by the resulting better heat transport, and a measurable change in resistance occurs. To over-write data, the tip makes a series of offset pits that overlap so closely their edges fill in the old pits, effectively erasing the unwanted data. More than 100,000 write/over-write cycles have demonstrated the re-write capability of this concept.

As a result of the foregoing complications and limitations, as well as others, what would be advantageous are methods, systems, and apparatuses for simplified addition and configuration of hard disk drive storage.

### BRIEF SUMMARY OF THE INVENTION

The present invention relates to stackable data storage devices. A data storage device can include a platter, a controller for reading data from and writing data to the platter, a housing enclosing the platter and controller, an interface configured to couple the controller to a central processing unit of a data processing system, and a receptacle configured to couple the controller to an interface of another data storage device.

A stackable data storage device is described. The stackable data storage device can include a storage medium, a controller for controlling storage of data on the storage medium, a housing enclosing the storage medium and the controller, a receptacle coupled to the controller. The receptacle can be configured to couple to an interface of another similarly configured stackable data storage device. An interface can be coupled to the controller. The interface can be configured to couple to a receptacle of another similarly configured stackable data storage device. The controller can include executable instructions that when executed on the controller instruct the controller to coordinate storage of data with another stackable data storage device.

A method for adding additional data storage device storage to a data processing system is described. The data processing system can include a central processing unit coupled to a first stackable data storage device. The first stackable data storage device can include a first data storage medium, a first controller, a first interface coupled to the first controller, a first receptacle coupling the first controller to the central processing unit, and a first housing enclosing the first data storage medium and the first controller. The method can include coupling a second receptacle of a second stackable data storage device to the first interface of the first stackable data storage device. The second stackable data storage device can include the second interface coupled to a second controller of the second stackable data storage device, a second interface coupled to the second controller, a second data storage medium, and a second housing enclosing the second controller and the second data storage medium.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a conventional hard disk drive and typical components found therein;

FIG. 2 illustrates a stackable hard disk drive according to an example embodiment of the present invention;

FIG. 3 illustrates an embodiment of the present invention depicting a direction in which two stackable hard disk drives can be stacked;

FIG. 4 illustrates a stackable hard disk drive including a RAID controller according to an example embodiment of the present invention;

FIG. 5 is a side view illustration of a stackable hard disk drive including a RAID controller according to an example embodiment of the present invention;

FIG. 6 illustrates an example embodiment where three stackable hard disk drives are coupled to a processor are coupled in a distributed manner within a computer; and

FIG. 7 illustrates an example embodiment of the present invention where an analyzer monitors data transfer between several stacked hard disk drives and/or data transfer from at least one hard disk drive and a CPU.

### DETAILED DESCRIPTION OF THE PREFERRED EMBODIMENTS

Embodiments of the present invention relate to stackable data storage devices. The principles of the present invention are described with reference to the attached drawings to illustrate the structure and operation of example embodiments used to implement the present invention. Using the diagrams and description in this manner to present the invention should not be construed as limiting its scope. Additional features and advantages of the invention will in part be obvious from the description, including the claims, or may be learned by the practice of the invention.

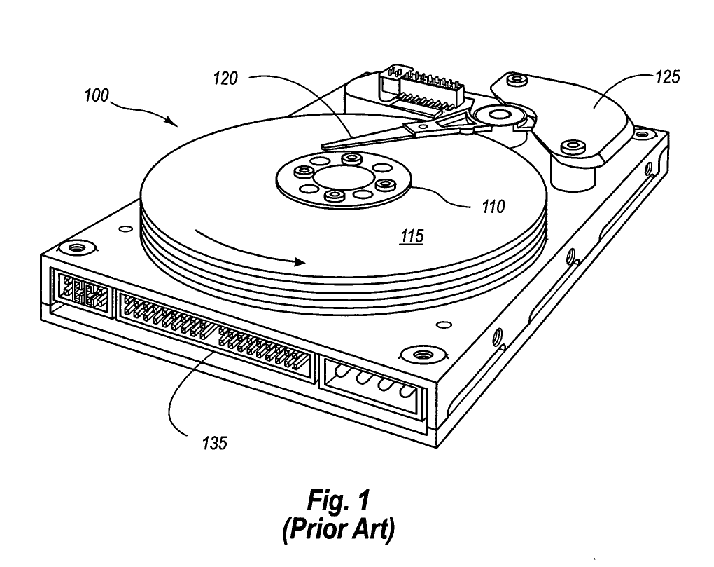

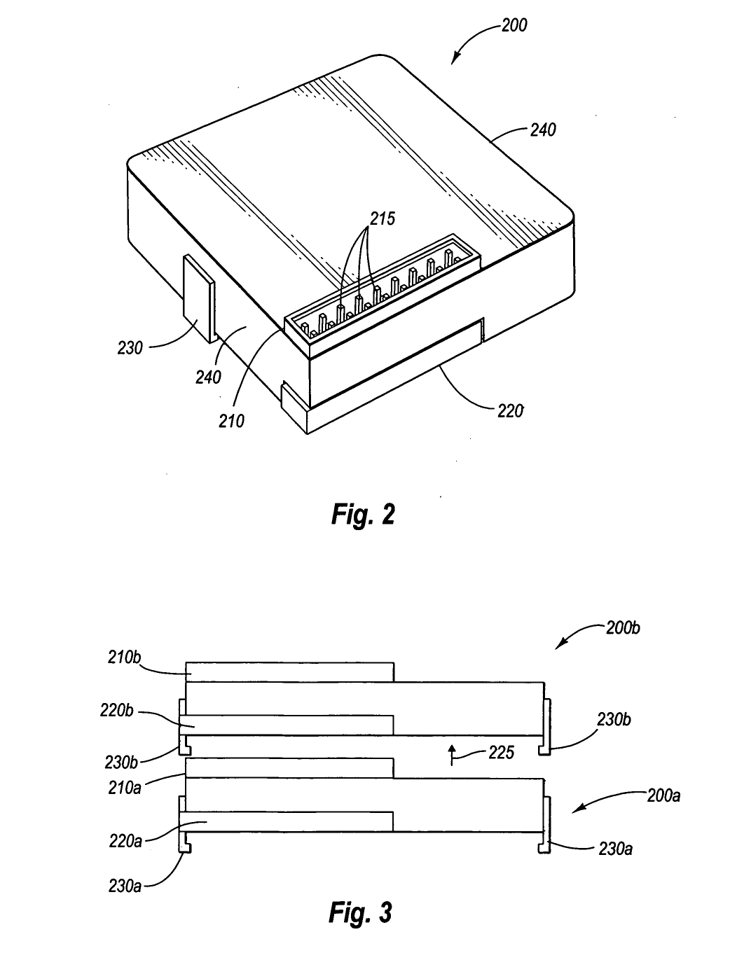

Referring to FIG. 2, an external perspective view of a stackable hard disk drive 200 is illustrated according to an example embodiment of the present invention. The stackable hard disk drive 200 can include several of the internal components of a conventional hard disk drive. For example, the internal components of the stackable hard disk drive 200 can include a motor, spindle, platters, read/write heads, actuator, frame, air filter, and drive electronics similar to that discussed above with reference to FIG. 1. The stackable hard disk drive 200 illustrated in FIG. 2, however, can include an interface 210 for providing a connection with another similarly configured stackable hard disk drive. The stackable hard disk drive 200 can further include a receptacle 220 for receiving an interface from another similarly configured stackable hard disk drive. The interface 210 and receptacle 220 can have connections 215, such as pins or contracts, configured similar to an ATA-type interface and receptacle, or other appropriate interface used for hard disk drive connection. However, the interface 210 and receptacle 220 can also be designed specifically for the stackable hard disk drive 200. The interface 210 and receptacle 220 can include appropriate connections to communicate data and instructions, as well as power connections for providing power to downstream stackable drives 200. An entirely different interface and receptacle can also be used for transferring power and/or instructions between the stackable hard disk drives. The interface 210 and receptacle 220 enable the stackable hard disk drive 200 to communicate and coordinate the transfer, storage, and retrieval of data between multiple stacked hard disk drives. Other types of data storage devices can be configured in a similar manner, for example data storage devices containing magnetic, optical, flash, and Millipede media.

When one drive is stacked on top of another, the interface 210 of a first drive mechanically and electrically connects with a receptacle 220 of a second drive. Firmware included in either of the hard disk drives can be used to automatically configure the hard disk drives. This can include identifying master or slave status, identifying the second drive's role in a RAID system, configuring the second drive, and the like. The storage unit could also communicate with the units stacked on it to obtain smart data.

According to an example embodiment, only a target drive that is attached to the cable running directly to the mother board (or controller card) talks to the computer's operating system (e.g. using low level file system device drivers). The target hard disk drive can send the commands to the stacked drives(s) in different ways. For example, the target hard disk drive can send commands to the stacked, drive(s) as if the attached drive(s) was a slave drive, but instead of resending it on the main cable it can resend the command on the interconnecting interface (e.g. interface 210 or an interconnecting cable).

The target drive can also communicate with the stacked drive(s) by interpreting a command received and only sending vital parts of the command to the stacked drive(s). For example, the target drive can send read or write portions of the command, along with logical block addresses (LBAs) to the stacked drive(s). The firmware on the target drive that talks on the cable back to the computer can also be used to “upgrade” the firmware on the stacked drive(s).

A stacked drive can also upgrade the firmware on the target drive. In this manner, if a firmware upgrade fails, a drive is not useless. For example, the stacked drive(s) can take control of the bus until the firmware upgrade is completed successfully on the target drive attached to the cable. This can be done by the stacked drive though control of the interface chip on the board of the target drive attached to the cable (or by swapping the drive attached to the cable). This can include identifying a master or slave status of the target drive.

A stacked drive need not be assigned a “master or slave” configuration. According to this embodiment, only the target drive attached to the bus and handling the bus protocol need have a master or slave attribute. The stacked drive(s) can be neutral and accept its commands from the target drive that it is stacked upon. In this embodiment, the stacked drive(s) would not have any access to the bus. Thus, the stacked drives would not have a Master/Slave setting and would ignore its jumpers (if any) in that instance.

Other interfaces, such as SAS and SCSI, would not have a master/slave option to start with. The stacked drive would not “talk” on the interface, but rather the stacked drive(s) would talk “through” the drive(s) that it is stacked upon

The stackable hard disk drive 200 can include an attachment feature for attaching a stackable hard disk drive 200 in a fixed position in relation to another stackable hard disk drive 200. For example, the stackable hard disk drive 200 can include clips 230 that engage side portions 240 of another stackable hard disk drive and fix the stackable hard disk drive 200 in a connected position with another stackable hard disk drive. It should be appreciated that any type of attachment feature or assembly may be used, such as glue, epoxy, mechanical features, screws, bolts, press fit features, as well as other types of features and assemblies for attaching the stackable hard disk drive 200 in an at least temporarily fixed position relative to another stackable hard disk drive.

Referring to FIG. 3, an embodiment of the present invention is shown depicting a direction 225 in which two stackable hard disk drives 200a and 200b can be stacked. The stackable hard disk drives 200a-b can be stacked in any number, one drive on top of the other. The interface 210a of a lower stackable hard disk drive 200ais received by the receptacle 220b of the upper stackable hard disk drive 200b stacked thereon. The stackable hard disk drives 200a-b can be attached together using clips 230b.

Each stackable hard disk drive 200a-b can include circuitry and firmware including instructions that enable the stackable hard disk drives 200a-b to communicate with each other. The firmware can include instructions that when executed configure the two stackable hard disk drives 200a-b to coordinate the storage of data and cause the stackable hard disk drives 200a-b to function in a desired manner. For example, where the stackable hard disk drives 200a-b are intended to simply increase the size of an available desktop storage hard disk drive volume, at least one of the stackable hard disk drives 200a-b can include executable instructions that allocate the additional hard disk drive space for use by the desktop computer. The firmware can be configured to report the total combined size of the two stackable hard disk drives 200a-b as a single storage volume. The firmware can include instructions where a partition or other storage allocation is automatically set up and reported to the desktop. The stacked disk drives can communicate with the target disk drive coupled to the cable. The target disk drive can communicate with the processor to coordinate storage of data on the target disk drive as well as the stacked disk drives.

The stackable hard disk drives 200a-b can also include firmware that can work in conjunction with software downloaded by the desktop, from a disk, or from one of the stackable hard disk drives 200a-b. The firmware can automatically configure the disks or allow a user to use the desktop to interactively set up the storage volume in a desired manner. The interactive setup software can also include additional instructions and explanatory description tailored to the particular user. For example, where the stackable drives 200a-b are targeted toward less experienced computer users, the interactive software can include additional description and instructions, and/or limit the number of customizations available to the user. However, where the stackable drives 200a-b are targeted for a more an advanced experienced user, the interactive software can include additional advanced setup options allowing the user to customize the stackable hard disk drives 200a-b in additional manners.

Firmware can be similar to that stated above where the target drive on the cable resends the commands to the stacked drives as if they were slave drives. The firmware on the stacked drives can also “know” that it was assigned LBAs that are one more increment than those of the target (or stacked) drive that it was stacked on top of. For example, if the stacked drive has 40000 LBAs and the target drive on the cable has 40000 LBAs, the stacked drive's first LBA in this case would be 40000 (LBAs start at 0). The stacked drive has 39,999 additional LBAs, and as a result the stacked drive's last LBA would be 79999. An LBA of 79999 would indicate to the target drive that the command is for the stacked drive. An LBA of greater than 79999 can indicate that the command is for an additional stacked drive, and if no additional stacked drive is present then the command would be rejected as an invalid LBA.

A stacked drive can send it's response on the interface to the target drive on the cable where it would be sent down the cable to the processor. The stacked drive can also “negotiate” width the target drive for control over the cable and the interface chip on the target drive connected to the cable. In this manner, the stacked drive can send the data to the processor itself.

A stacked drive can also receive the essentials of the command on the cable and decode whether it was for itself or for an additional drive stacked upon it by the LBA. The stacked drive can determine whether to respond or send it to the additional drive accordingly. The stacked drive can then send the response back down the interconnect of interfaces and receptacles to the target drive on the cable for it to respond. Since the stacked drive did not have the command, it could not take control of the interface back to the computer and respond on its own.

According to these example embodiments, a simple and convenient method for increasing a hard disk drive storage volume may be implemented without the confusing and potentially daunting conventional steps described above. Expansion of storage capacity can be as simple as simply stacking one drive on top of another, the firmware can be set to provide a default configuration. Once the drives are stacked together, the operating system simply recognizes a new drive or a bigger drive, for example.

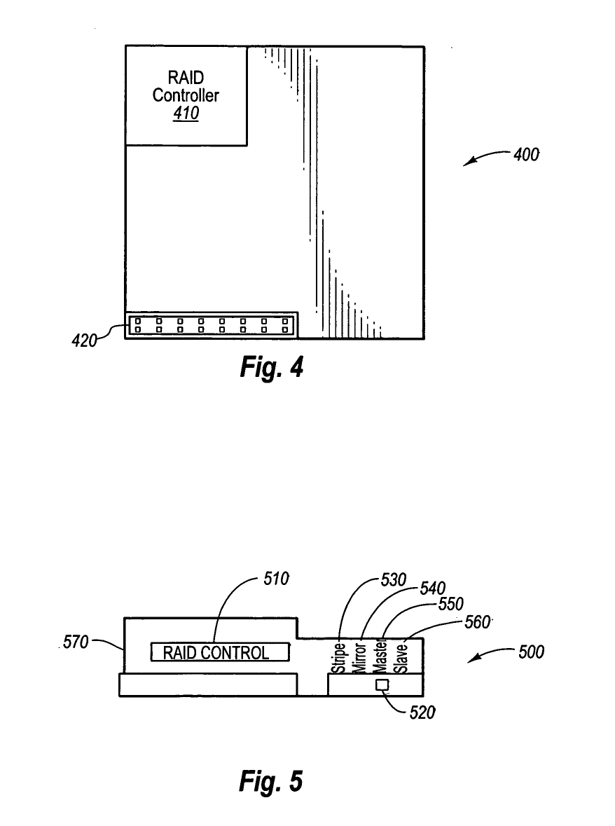

Referring now to FIG. 4, a stackable hard disk drive 400 including an internal RAID controller 410 is shown according to an example embodiment of the present invention. The stackable hard disk drive 400 includes an interface 420 for connection to another similarly configured stackable hard disk drive. The RAID controller 410 can be a microprocessor, or other logical circuitry, configured to control and configure the allocation of data storage between multiple stackable hard disk drives 400. The RAID controller 410 can include firmware instructions that when executed by the RAID controller 410 cause the RAID controller 410 to store data on the stackable hard disk drive 400, or on another stackable hard disk drive coupled to the stackable hard disk drive 400. For example, where the firmware of the RAID controller 410 includes instructions that cause the stackable hard disk drive 400 to act as a mirror, the RAID controller 410 can create and store a second copy of data that is stored on another stackable drive coupled to the stackable drive 400 on the stackable hard disk drive 400. Similarly, where the RAID controller 410 includes instructions that cause the stackable hard disk drive 400 to act as a striped drive, the RAID controller 410 can act independently of, or in conjunction with another RAID controller, to distribute the data storage between two stacked hard disk drives.

The RAID controller 410 can also work in conjunction with a desktop, and executable instructions (e.g. software) loaded onto the desktop, to configure and control the storage of data on the stackable hard disk drive 400, or an array of stackable hard disk drives 400. In this manner, user input and instructions can be received by the desktop and can provide instructions for the RAID controller 410 to coordinate the storage of data therein.

Referring now to FIG. 5, a side view of a stackable hard disk drive 500 including a RAID controller 510 is shown according to an example embodiment of the present invention. The stackable hard disk drive 500 can include a selectable switch 520 for enabling a user to select a desired state of the stackable hard disk drive 500. The switch 520 can include a position for selecting a stripe configuration 530, a mirror configuration 540, a master configuration 550, and a slave configuration 560. In this manner, a user can use the manual switch 520 to select the desired configuration of the stacked hard disk drive 400 as the hard disk drive is coupled to another stacked hard disk drive. The stacked hard disk drive 400 can include any number of selections and selectable configurations.

The RAID controller 510 can include instructions for allowing the stackable hard disk drive 500 to act as any number of components in any of the known RAID distributed hard disk drive conventions. The selectable configurations can also include conventional Master 550 and Slave 560 positions if desirable, allowing for a simple configuration of the stackable drive 500 to increase storage size and also RAID configuration.

In some example embodiments, Master/Slave applies only to the target drive talking on the interface. All storage units (e.g., drives) stacked onto another storage unit can be subservient to the target storage unit that they are stacked on top of that is the storage unit talking on the interface coupled to the CPU. The stacked storage units become part of the target storage unit talking on the interface where the storage units have their own firmware, media, and electronics. In some embodiments implementing ATA, the host computer only talks to the Master storage unit on the cable. The Host computer sets a bit to specify whether the command is for the master storage unit or the slave storage unit. If the bit is for the slave storage unit the master storage unit sends the command to the slave storage unit. The target storage unit is a storage unit that has additional storage units stacked to it and is coupled to a cable leading directly to the CPU. The target disk storage unit can be a Master storage unit or a Slave storage unit on an ATA cable, for example. However, the target storage unit is the target of the host computer and it talks to all the storage units stacked to it. According to embodiments of the present invention, however, the target storage unit does not have to be a Master or Slave if the bus is not on an ATA bus.

In some configurations, a stacked drive or the target drive may be required to disable the RAID controller 510, or the RAID controller 510 may not be necessary for the drive to function. For example, the RAID controller can be an optional part of a control processor located on each drive. Embodiments can be tailored to the particular configuration using firmware, or a selectable control (e.g. a switch 520 or other means) can be implemented whereby the RAID controller 510 is temporarily disabled, or not entirely implemented. The switch can be useful to “hard set” which of the stacked drives has control of the bus (i.e. the cable back to computer or controller) for upgrading firmware.

Conventional field upgrades of firmware can be difficult. Thus, embodiments of the present invention may lower the risks experienced with field upgrades of firmware. For example, the target drive on the interface can save a copy of the firmware for the stacked drive then attempt to upgrade it. If the upgrade fails, the target drive can restore the original firmware on the stacked drive. The interconnect between the drives can be configured in a manner to give the target drive the ability to actually control the servo, memory, read/write capabilities of the stacked drive(s) such that if an upgrade fails, the target drive can control the stacked drive(s) and access the data from it. While performance of the hard disk drives may suffer, this may prevent loss of data in some instances.

The RAID controller 510 can include instructions that allow the RAID controller 510 to work in conjunction with other RAID controllers to coordinate the allocation, storage, and retrieval of data in a customized and desired manner. For example, the RAID controller 510 can include instructions that mirror only the data stored on the stackable hard disk drive directly coupled in an upstream position from the stackable hard disk drive 500, but allow other data to pass through the stackable hard disk drive 500 to an additional stackable hard disk drive acting in a striped configuration down stream. Thus, the RAID controller 510 can include firmware, or receive instructions from a desktop, so that the stackable hard disk drives work in a coordinated and distributed manner to store data as desired by a user.

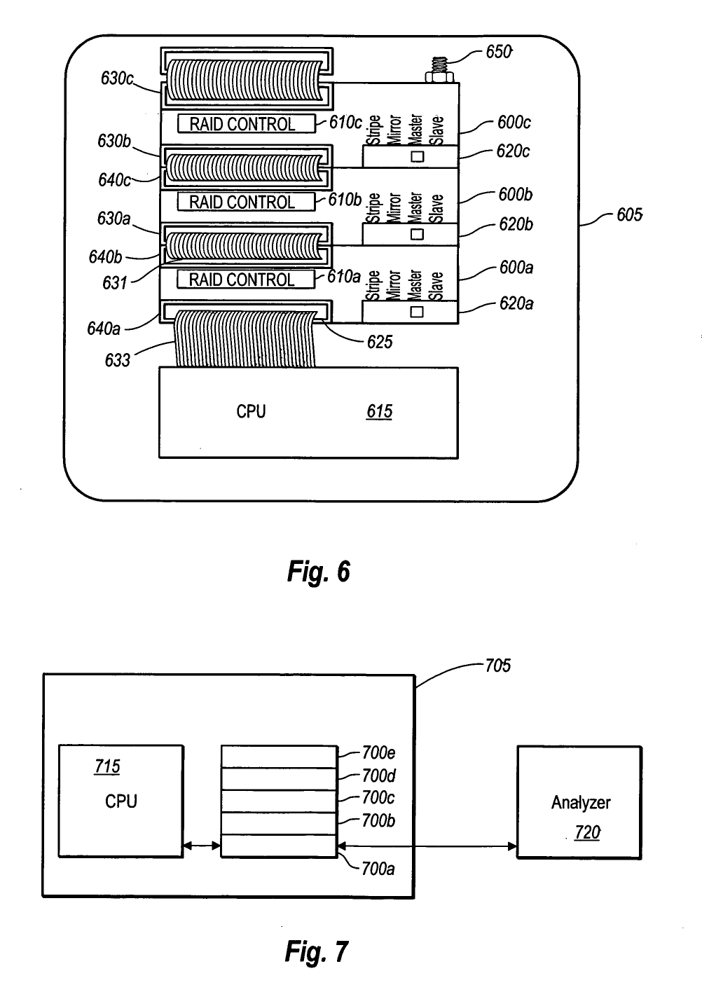

Referring now to FIG. 6, an example embodiment is shown where three stackable hard disk drives 600a, 600b, 600c are coupled to a CPU 615 in a distributed manner within a computer 605 or other data processing system or network. According to this embodiment, each stackable hard disk drive 600a-c can include a RAID controller 610a-c. The three hard disk drives 600a-c each include a selectable switch 620a-c for selecting a desired function such as Stripe, Mirror, Master, and Slave. However, according to this embodiment, only the target drive 600a on the cable going to the motherboard needs to be designated as Master or Slave in an ATA implementation. The first stackable hard disk drive 600a and the second stackable hard disk drive 600b can be selected as Stripe hard disk drives, and as such can distribute the storage and access of data between them. The third stackable hard disk drive 600c can be selected as a mirror hard disk drive, for example, and can be configured to mirror the data stored in the second stackable hard disk drive 600b.

Each stackable hard disk drive 600a-c is coupled to another stackable hard disk drive 600a-c using an interface 630a-c and receptacle 640a-c. Each interface 630a-c can include a ribbon IDE interface, such as a conventional 40 or 80 wire IDE ribbon interface. As such, embodiments of the stackable drive 600a-c can be configured to connect to conventional hard disk drive interfaces and allow for configuration of a particular stackable hard disk drive with various different conventional hard disk drive configurations. In one embodiment, however, the wire ribbon connecting two stackable drives is separate and distinct from the ribbon connecting the first drive to the computer.

The first stackable drive 600a can be coupled to an interface 625 that is coupled to the CPU processor 615 of the computer 605. In this case, the receptacle 640a of the first stackable drive 600a can be an ATA, IDE, SAS, SATA, or other receptacle for receiving a CPU interface 625 and allowing for the CPU 615 to store data on the stacked drives 600a-c according to the settings and configurations of the stacked drives 600a-c. The interface 625 also allows for the CPU 615 to access the data stored on the stacked drives 600a-c. The RAID controller 610a-c can also be in communication through the interface 625 with the CPU 615 and coordinate the storage of data on the stacked drives 600a-c as specified by a user or a manufacturer of the stacked drives 600a-c. The coordination of the storage of data can be collaboratively determined between the CPU 615 and firmware stored in at least one of the RAID controllers 610a-c along with, or instead of, manual settings using the switches 620a-c. The coordination of the distributed RAID storage can also be accomplished using software on the CPU and input from a user into a user input device coupled to the computer 605, such as a keyboard or mouse.

The connection between the drive 600a and the drive 600b is the wire ribbon 631. The wire ribbon 633 connects the drive 600a with the CPU 615. In other words, the drives 600b and 600c are not directly connected to the CPU 615, but are coupled to the CPU 615 through the drive 600a.

The stackable hard disk drives 600a-c can be physically held together using a nut and bolt attachment means 650. Any appropriate attachment means can be used to fix the stackable hard disk drives 600a-c with relation to each other as discussed above. The stackable hard disk drives 600a-c have been shown as a substantially rectangular shape, where the hard disk drives in a substantially vertical alignment. However, the stackable hard disk drives 600a-c can be different shapes and configurations and can be oriented in different relative positions and alignments.

Referring now to FIG. 7, an analyzer 720 coupled to several stacked hard disk drives 700a-e is illustrated according to an example embodiment of the present invention. A computer 705 can include a CPU 715 and several hard disk drives 700a-e coupled to the CPU 715. The analyzer 720 can be coupled to at least one of the hard disk drives 700a-e for analyzing data transfer between the stacked hard disk 700a-e drives and/or the hard disk drives 700a-e and the CPU.

The analyzer 720 can monitor data transfers between the different stacked disk drives 700a-e and the between the stacked disk drives 700a-e and the CPU 715. The analyzer 720 can include an interface, such as ATA, IDE, SAS, SATA, or other interface for coupling the analyzer 720 to the hard disk drives 700a-e or the CPU 715. The analyzer 720 can analyze the data transmissions between the stacked disk drives 700a-e and/or the CPU 715 for errors in the data, for protocol errors, for specific data types, or for errors in hardware, for example.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A data storage device comprising:
a platter;
a controller for reading data from and writing data to the platter;
a housing enclosing the platter and controller;
an interface configured to couple the controller to a central processing unit of a data processing system; and
a receptacle configured to couple the controller to an interface of another data storage device.

2. A data storage device according to claim 1, wherein the interface is further configured to couple the data storage device to another data storage device.

3. A data storage device according to claim 1, wherein both the interface and the receptacle conform to an Advanced Technology Attachment protocol, a SCSI protocol, or a Serial ATA protocol.

4. A data storage device according to claim 1, wherein the controller includes RAID instructions for coordinating storage between multiple data storage devices according to a RAID standard.

5. A data storage device according to claim 4, wherein the RAID standard includes at least one of a mirrored and a striped distribution of data storage between multiple data storage devices stacked upon each other.

6. An analyzer for analyzing data transfer between a data storage device according to claim 1 and at least one of another data storage device according to claim 1 or a computer processing unit of a computer.

7. A computer system comprising the data storage device of claim 1.

8. A stackable data storage device comprising:
a storage medium;
a controller for controlling storage of data on the storage medium;
a housing enclosing the storage medium and the controller;
a receptacle coupled to the controller, wherein the receptacle is configured to couple to an interface of another similarly configured stackable data storage device;
an interface coupled to the controller, wherein the interface is configured to couple to a receptacle of another similarly configured stackable data storage device; and
wherein the controller includes executable instructions that when executed on the controller instruct the controller to coordinate storage of data with another stackable data storage device.

9. A stackable data storage device according to claim 8, wherein the interface is also configured to couple to an Advanced Technology Attachment interface, a SCSI interface, or a Serial ATA interface.

10. A stackable data storage device according to claim 8, wherein the storage medium comprises a plurality of platters and a plurality of heads for reading from and writing to the plurality of platters.

11. A stackable data storage device according to claim 8, further comprising attachment means for securing the data storage media to another stackable data storage device, wherein the stackable data storage device is a target stackable data storage device coupled to a CPU.

12. A stackable data storage device according to claim 8, wherein the controller, or a separate controller, is a RAID controller for coordinating data storage on a second stackable data storage device according to a RAID standard.

13. A stackable data storage device according to claim 12, wherein the RAID controller includes executable instructions stored thereon that instruct the RAID controller to operate in at least one of a mirror mode, a striped mode, a master mode, and a slave mode.

14. A stackable data storage device according to claim 12, further comprising:
a switch for selecting at least one function of:
a mirror function;
a striped function;
a master function; and
a slave function.

15. An analyzer for analyzing data transfer between a stackable data storage device as set forth in claim 8 and at least one of a central processing unit or another data storage device as set forth in claim 8.

16. An analyzer according to claim 15, wherein the analyzer includes executable instructions for monitoring data transfer between the stackable drives.

17. A data processing system comprising the stackable data storage device of claim 8.

18. A method for adding additional data storage device storage to a data processing system, the data processing system including a central processing unit coupled to a first stackable data storage device, the first stackable data storage device comprising a first data storage medium, a first controller, a first interface coupled to the first controller, a first receptacle coupling the first controller to the central processing unit, and a first housing enclosing the first data storage medium and the first controller, the method comprising:
coupling a second receptacle of a second stackable data storage device to the first interface of the first stackable data storage device, the second stackable data storage device comprising the second interface coupled to a second controller of the second stackable data storage device, a second interface coupled to the second controller, a second data storage medium, and a second housing enclosing the second controller and the second data storage medium.

19. A method according to claim 18, wherein the first and second interfaces are configured to couple to an Advanced Technology Attachment interface, a SCSI interface, or a Serial ATA interface.

20. A method according to claim 18, further comprising releasably securing the second stackable data storage device to the first data storage device such that the second interface is received and coupled to the first receptacle.

21. A method according to claim 18, further comprising:
providing RAID control for controlling the storage of data on the stackable data storage devices according to a RAID standard.

22. A method according to claim 21, wherein the RAID control provided includes at least one of mirrored RAID data storage control and striped RAID data storage control.

23. A method according to claim 18, further comprising:
coupling a third receptacle of a third stackable data storage device to the second interface of the second stackable data storage device, wherein the third receptacle is coupled to a third, controller of the third stackable data storage device, a third interface is coupled to the third controller, and a third housing encloses the third controller and a third storage medium.
